(19) United States
(12) Patent Application Publication
(10) Pub. No.: US 2007/0272652 A1
(43) Pub. Date: Nov. 29, 2007

(54) Integral Handle Pet Container System

(76) Inventor: Glenn Robert Beale, New South Wales (AU)

Correspondence Address: LADAS & PARRY, 26 WEST 61ST STREET, NEW YORK, NY, 10023, US

(21) Appl. No.: 10/577,391

(22) PCT Filed: Oct. 22, 2004
(86) PCT No.: PCT/AU04/01459

§ 371 Date: Jun. 5, 2007

(30) Foreign Application Priority Data
Oct. 30, 2003 (AU) 2003905983

(51) Int. Cl. B65D 23/10; B29C 49/08

(52) U.S. Cl. 215/398; 264/531; 428/542.8

(57) ABSTRACT

A preform for a container comprised of orientable plastics material and arranged so that the resultant blown container will include a hollow handle; said preform comprising a moulded structure having a neck portion and an expandable portion below the, neck, a hollow handle portion of orientable plastics material integrally connected at least at a first end to said preform which when the container is formed constitutes said handle, and wherein interior surfaces of said hollow handle portion form a continuum with interior surfaces of said expandable portion.

### INTRODUCTION

This invention relates to a preform or parison, and methods of manufacture thereof and, more particularly, a preform from which a container with an integrally connected hollow handle may be blown biaxially.

### BACKGROUND OF THE INVENTION

Attempts have been made to incorporate integral handles in PET and like injection blow moulded containers—for example see U.S. Pat. No. 4,629,598 to Thompson, assigned to Tri-Tech Systems International, Inc. The parison or preform from which the handled bottles of U.S. Pat. No. 4,629,598 are produced is illustrated in FIG. 1. To date, however, attempts to produce a practical, mass produced version of this arrangement have been unsuccessful. Instead, the best that appears to have been done in commercial practice is an arrangement whereby the blown containers are arranged to accept a clip on or snap on handle in a separate production step after the container itself is formed. See for example WO82/02371 and WO82/02370, both to Thompson.

Stretch blow-moulded containers incorporating an integral solid handle, but not subject to the stretch blow moulding process of the body of the container, were disclosed by the present inventor in WO 96/33063A1, WO 99/12715A1, WO 99/30883A1 and WO 00/26001A1.

Injection-stretch-blow moulding is a process in which the preform is stretched both axially and radially, resulting in biaxial orientation. Biaxial orientation provides increased tensile strength (top load), less permeation due to tighter alignment of the molecules, and improved drop impact, clarity and lighter weight of the container.

The process is the only one suitable for producing larger bottles in PET, either as single layer or multi-layered. The difficulty of including an integral handle resides in the production of the preform, particularly in the case of a hollow handle, and in the heat curing preparation of the necessarily non-symmetrical preform immediately prior to the blow moulding operation. Hollow handles are however desirable because of the reduced amount of material required, their greater strength and improved appearance.

As well, the process of heat preparation of the preform is very complicated and difficult with solid handles which, because they do not partake of the stretch-blow mould process, require complex shielding from excessive heating.

Not all thermoplastics can be oriented. The major thermoplastics used are polyethylene terephthalate (PET), polyacrylonitrile (PAN), polyvinyl chloride (PVC), and polypropylene (PP). PET is by far the largest volume material, followed by PVC, PP, and PAN.

The amorphous materials, e.g., PET, with a wide range of thermoplasticity are easier to stretch-blow than the partially crystalline types such as PP. Approximate melt and stretch temperatures to yield maximum container properties are:

| Material | Melt, Degrees C. | Stretch, Degrees C. |
|---|---|---|
| PET | 280 | 107 |
| PVC | 180 | 120 |
| PAN | 210 | 120 |
| PP | 240 | 160 |

There are basically two types of processes for stretch-blow moulding:
1) single-stage in which preforms are made and bottles blown on the same machine, and
2) two-stage in which preforms are made on one machine and blown later on another machine.

Single-stage equipment is capable of processing PVC, PET, and PP. Once the parison is formed (either extruded or injection moulded), it passes through conditioning stations which bring it to the proper orientation temperature. The single-stage system allows the process to proceed from raw material to finished product in one machine, but since tooling cannot be easily changed, the process is best suited for dedicated applications and low volumes.

Many oriented PET containers are produced on single-stage machines. Preforms are first injection moulded, then transferred to a temperature conditioning station, then to the blow moulding operation where the preforms are stretch-blown into bottles, and finally to an eject station.

With the two-stage process, processing parameters for both preform manufacturing and bottle blowing can be optimized. The two-stage process is the lowest-cost method to produce oriented PET containers. This method, which provides injection moulding of the preform and then shipping to blow moulding locations, allows companies to become preform producers and to sell to blow moulding producers. Thus companies that wish to enter the market with oriented PET containers can minimise their capital requirements.

A processor does not have to make compromises for preform design and weight, production rates, and bottle quality as he does on single-stage equipment. He can either make or buy preforms. And if he chooses to make them, he can do so in one or more locations suitable to his market. Both high-output machines and low output machines are available.

It is an object of the present invention to produce an injection, stretch blow moulded container made from an orientable plastics preform incorporating a hollow handle integrally connected at least at one point to the preform.

### SUMMARY OF THE INVENTION

Accordingly, there is provided in a first broad form of the invention a preform for a container comprised of orientable plastics material and arranged so that the resultant blown container will include a hollow handle; said preform comprising a moulded structure having a neck portion and an expandable portion below the neck, a hollow handle portion of orientable plastics material integrally connected at least at a first end to said preform which when the container is formed constitutes said handle, and wherein interior surfaces of said hollow handle portion form a continuum with interior surfaces of said expandable portion.

In a second broad form of the invention there is provided a method of moulding a preform comprising a neck portion, a substantially cylindrical expandable body portion and a hollow handle portion integrally connected at least at one point to said expandable body portion; said method comprising the steps of:
(a) preparing an injection moulding die in which the exterior form of said body portion and said handle portion of said preform are defined by a cavity formed by cooperating halves of said injection die,
(b) preparing a main body forming mandrel for insertion into said cavity; said mandrel provided at an outer end with a control module,
(c) providing a passage extending from said control module substantially centrally through said mandrel; said passage curving to emerge at a side of said mandrel opposite said at least one point,
(d) providing a flexible handle mandrel controlled by said control module; said mandrel adapted for insertion through said passage and into said handle portion of said cavity.

Preferably, said flexible mandrel is an inflatable flexible tube of heat resistant material.

Preferably, said tube is sealed at an outer end.

Preferably, said outer end is provided with a solid tip projecting through said outer end.

Preferably, said tip is of substantially cylindrical form, said tip oriented with its axis substantially aligned with the axis of said tube.

Preferably, the diameter of said tip defines the diameter of the interior of the hollow handle when formed.

Preferably, a cable extends through said tube from said control module to said tip.

Preferably, said control module is adapted to extend and retract said tube.

Preferably, said control module is adapted to inflate and deflate said tube.

Preferably, said method for moulding a preform with a hollow handle attached at one point to said body comprises the further steps of:
(e) providing a first injection gate at an outer end of said handle portion of said cavity,
(f) inflating said tube so as to completely fill said handle portion of said cavity,
(g) injecting a flowable plastic material through said gate so as to envelop said tip,
(h) arranging said control module to partially deflate said tube,
(i) arranging said control module to gradually withdraw said tube from said handle portion of said cavity at a rate commensurate with the injection rate of said flowable material,
(j) injecting said flowable material through a second injection gate at an outer end of said body portion of said cavity,
(k) continuing injection of flowable material through both gates until said tip bridges a gap between said handle portion and said main body forming mandrel,
(l) withdrawing said tube and said tip into said main body forming mandrel,
(m) continuing injection of flowable material to completely fill said cavity.

Preferably, said method for moulding a preform with a hollow handle connected at two points to said body; said handle extending form a first connection point to a second connection point, said method comprises the further steps of:
(n) providing a pocket for nesting said tip in said main body mandrel opposite said second connection point,
(o) inserting said tube through said handle portion of said cavity to nest said tube in said pocket,
(p) inflating said tube,
(q) injecting flowable material through an injection gate at an outer end of said main body portion of said cavity,
(r) continuing said injection of flowable material until said material envelops said tip,
(s) gradually withdrawing said tube commensurate with a rate of injection of said flowable material so as to maintain said tip enveloped by said material,
(t) pausing withdrawal of said tube when said tip bridges a gap between said handle portion and said main body forming mandrel at said first connection point,
(u) withdrawing said tube and said tip into said main body forming mandrel,
(v) continuing injection of flowable material to completely fill said cavity.

In yet a further broad form of the invention there is provided a method of forming a container of plastic material having an integral hollow handle; said method comprising:
(w) forming a preform according to any one of claims 2 to 12, having a neck portion and an expandable portion below the neck portion, said preform having a hollow handle portion integrally connected at least at a first end to said preform, and
(x) preheating said preform to condition said plastic material,
(y) performing a blow moulding operation on said preform to expand the expandable portion and said handle portion to form the body and handle of said container.

In a still further form of the invention there is provided a container provided with a hollow handle, said handle integrally connected to at one point to said container, said container formed by stretch blow-moulding from a preform according to any one of claims 2 to 11, wherein an outer end of said handle is separated by a gap from said container.

In still a further broad form of the invention there is provided a container provided with a hollow handle, said handle integrally connected at least at one point to said container, said container formed by stretch blow-moulding from a preform according to any one of claims 2 to 11, wherein an outer end of said handle is adapted for at least partial capture within a portion of a wall of said container when said container is stretch blow-moulded from said preform.

In yet a further broad form of the invention there is provided a container provided with a hollow handle, said handle integrally connected to said container at a first point and a second point so as to allow the insertion of the fingers of a hand of a user, said container formed by stretch blow-moulding from a preform according to claim 12.

### BRIEF DESCRIPTION OF THE DRAWINGS

Embodiments of the present invention will now be described by way of example, with reference to the accompanying drawings, in which:

FIGS. 1A and 1B are elevation views of a preform and a container blown therefrom according to prior art,

FIG. 2 is a schematic of a typical injection die arrangement for the production of the preform of FIG. 1,

FIG. 3 is a partial side elevational view of a blow moulded PET container formed from a preform usable with one embodiment of the invention,

FIG. 4 is an end view and side view of a preform for the blow moulding of the container of FIG. 3,

FIG. 5 is a partial section view of an arrangement of an injection moulding die for the preform of FIG. 4 in a partially closed position,

FIG. 6 is a partial section view of the injection moulding die of FIG. 5 in a fully closed position,

FIG. 7 is a view of the internal arrangement of the injection die of FIGS. 5 and 6 for containers with an integrally attached hollow handle at a single point, at a first stage of operation,

FIG. 8 is a detail view of the arrangement of FIG. 7 after introduction of a flexible mandrel,

FIG. 9 is a detail view of the arrangement of the flexible mandrel of FIG. 8,

FIG. 10 is a detailed view of the flexible mandrel of FIGS. 8 and 9 at a first stage of an injection cycle,

FIG. 11 is a view of the preform at the completion of an injection cycle,

FIG. 12 is a part elevation view of a blow moulded container with hollow handle integrally attached at a first point and with an enveloped end portion of the handle,

FIG. 13 shows end and side views of a preform for the blow moulding of the container of FIG. 12,

FIG. 14 is a schematic of a two stage stretch blow moulding machine applicable to the process of the invention,

FIG. 15 shows the internal arrangement of an injection die for the moulding of a preform for a container with a hollow handle attached at two points at the beginning of an injection cycle,

FIG. 16 shows the injection die of FIG. 15 at a first stage of an injection cycle after insertion of a flexible mandrel,

FIG. 17 shows the injection die of FIGS. 15 and 16 with the preform at a partially moulded stage,

FIG. 18A shows a cavity of a stretch blow moulding die,

FIG. 18B shows the preform of FIGS. 15-17 in position in the cavity of FIG. 18A prior to the stretch blow moulding cycle,

FIG. 19A shows the preform of FIG. 18B after initial stretching of the preform prior to the blowing stage of the process.

FIG. 19B shows the container within the blow mould cavity at the completion of the blowing stage.

### DETAILED DESCRIPTION OF PREFERRED EMBODIMENTS

In this specification the term “integral connection” or “integrally connected” means a connection between the handle and the preform (and subsequently the corresponding connection on the container blown from the preform) which is made from the same material as the handle and the preform and is formed as an inherent part of, and at the same time as the preform is formed.

Integrally connected hollow handles for containers according to the present invention, may take a number of forms, including handles integrally connected at their upper end, that is towards the neck region of the container, or connected at two points so as to form a loop, the first point of connection being towards the neck region and a second point towards the bottom of the container, the loop allowing the insertion of at least some of the fingers of the hand for the lifting of the container.

Production of Preforms

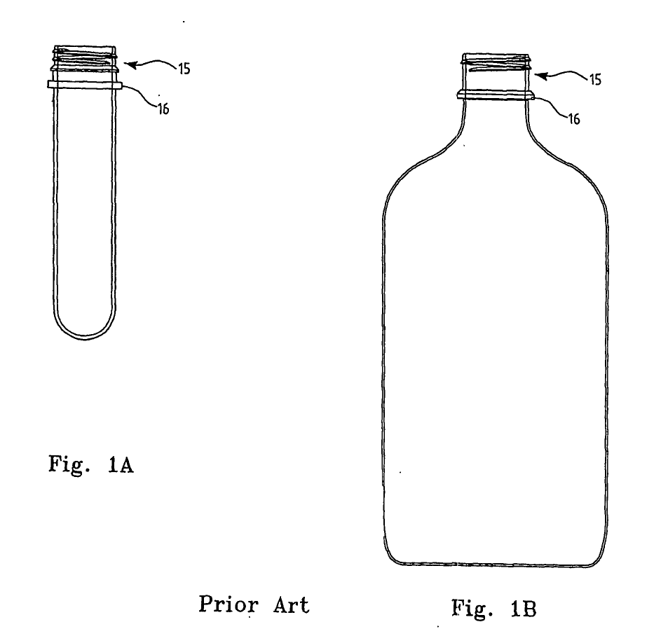

Conventionally, for PET containers such as bottles which either have no handle or to which a handle is attached as a subsequent production step after stretch blow-moulding, the preform is generally in the form of an elongate hollow cylinder closed at its lower end and formed with a neck portion adapted to accept a closure means such as a screw-on cap. Thus for example as shown in FIGS. 1A and 1B, the neck portion has a threaded section 15 and typically a retaining ring 16. The retaining ring 16 is adapted to provide location of the preform in the stretch-blow-moulding die.

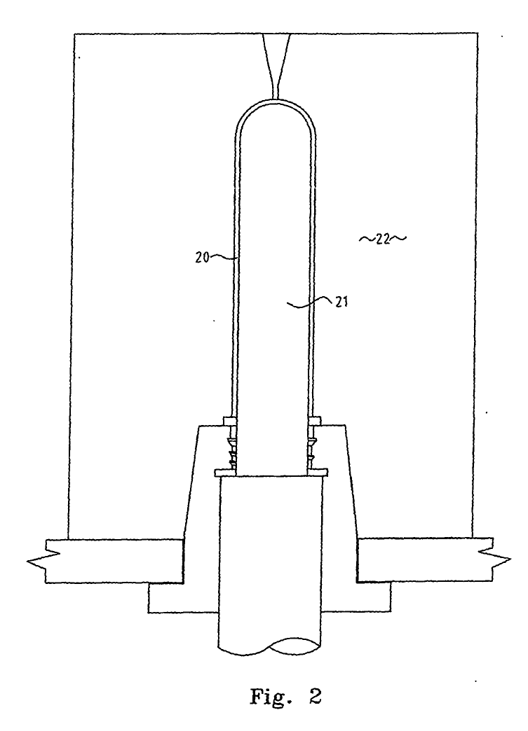

The injection moulding process is conventional in that the outer shape of the preform is defined by a cavity formed in two mating halves of the injection die, and the internal shape defined by a mandrel, the space between cavity and mandrel defining the wall thickness and neck detail of the preform. Molten PET is injected into this space and the die opened and the preform ejected off the mandrel after which the preform is allowed to cure. A typical cavity 20 and mandrel 21 for a PET bottle preform is shown in FIG. 2 which shows a portion of one half 22 of a typical single cavity injection die.

Before a preform can be stretch blow moulded, it must be heat conditioned to bring it to a desired state of plasticity. It is then placed in a blow moulding machine (not shown) and blow moulded according to biaxial orientation blow moulding techniques with the neck 15 and retaining ring 16 being held in the mould in such a way as not to expand. Initially, the expandable portion of the preform below the neck can be mechanically stretched towards the bottom forming portion of the mould following which the bulk of the preform is blown outwardly by application of compressed air to form a layer of material conforming to the inside surface of the mould cavity.

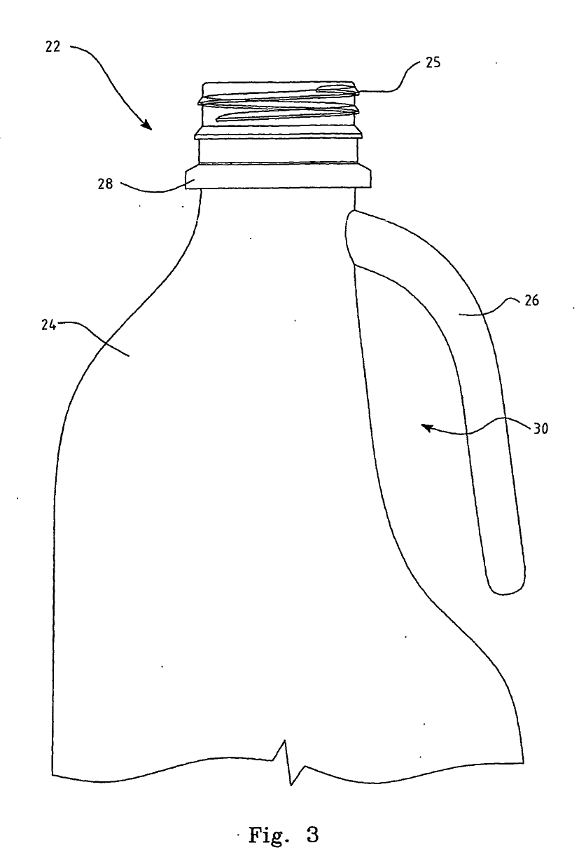

An upper portion of a container 20 according to an embodiment of the invention is shown in FIG. 3. It includes a neck 22, a main expanded body portion 24 and handle 26.

The neck 22 has a threaded portion 25 and a locating ring 28. Handle 26 is integrally connected somewhat below ring 28 and extends outwardly from the neck region and curves downwardly. The shape of the expanded main body of the container, in the region of the handle is such as to provide space 30 for the fingers of a hand. The handle and main body of the container are so arranged that the handle does not project outside an envelope defined by the lower part of the main body.

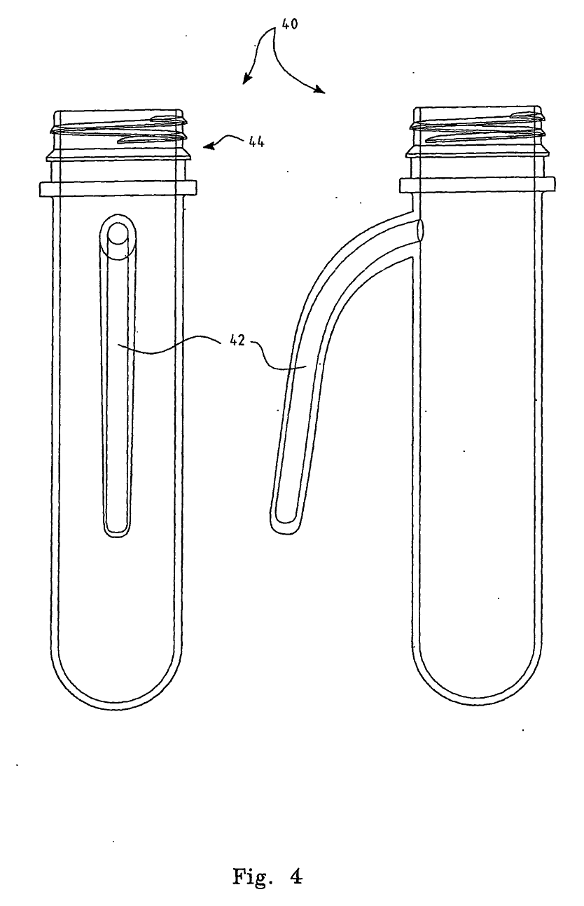

A preform for producing the container of FIG. 3 is shown in FIG. 4. It will be clear from FIG. 4 that the process of injection moulding a preform as described above for symmetrical containers, cannot accommodate the incorporation of a hollow handle projecting from some part of the preform, since the mandrel defining the interior of the handle would not be able to be extracted from the preform at the end of the preform moulding cycle.

### First Preferred Preform Embodiment

### Integral Handle, Single Point of Connection

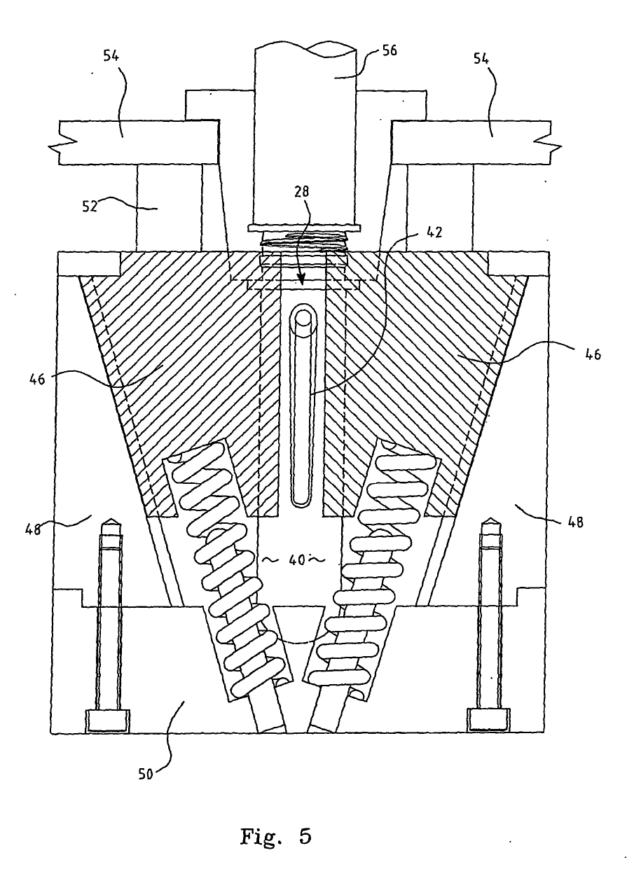

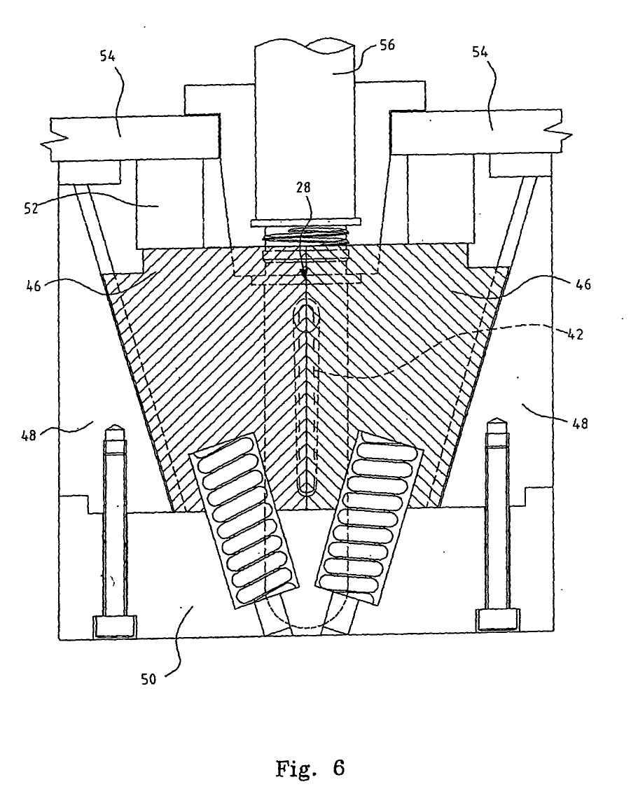

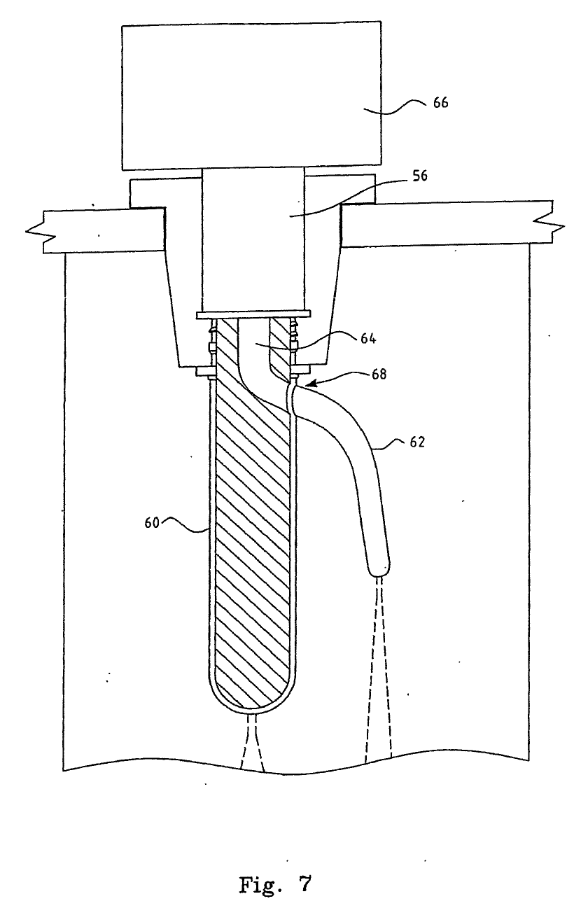

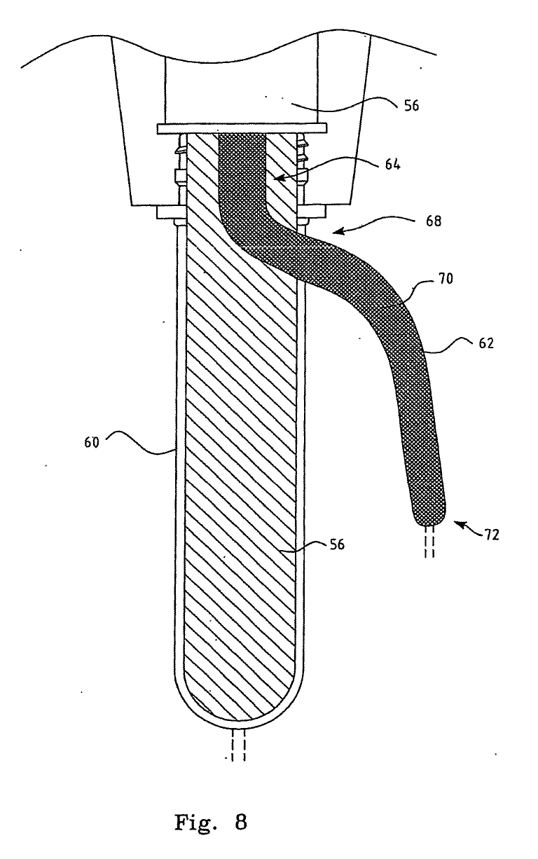

In a first preferred embodiment of the invention with reference to FIG. 4, a preform 40 is prepared having an integrally connected hollow handle 42 extending from a side of the preform below the neck portion 44 of the preform. An injection die suitable for the production of the preforms is shown in FIGS. 5 and 6 and includes sliding blocks 46, body 48, base 50, push block 52 and splits holder 54 as well as mandrel 56. FIG. 6 illustrates the die in the open position while FIG. 6 illustrates the die in the closed position. FIG. 7 illustrates a side view of one half of the die showing the cavity for forming the main portion 60 of the mandrel and for the handle hollow handle portion 62. (The detail of the sliding blocks arrangement is here omitted for clarity).

In the process for producing a preform with a hollow handle integrally connected, the mandrel 56, that is the mandrel forming the interior shape of the main body of the preform (henceforth referred to as the main mandrel and shown sectioned in FIG. 7) is provided with an internal passage 64 and is in communication with a control module 66. The passage extends partly along the axis of the mandrel but then curves towards the side and emerges opposite the connection point 68 of the handle as defined by the cavity 62 of the handle portion of the preform.

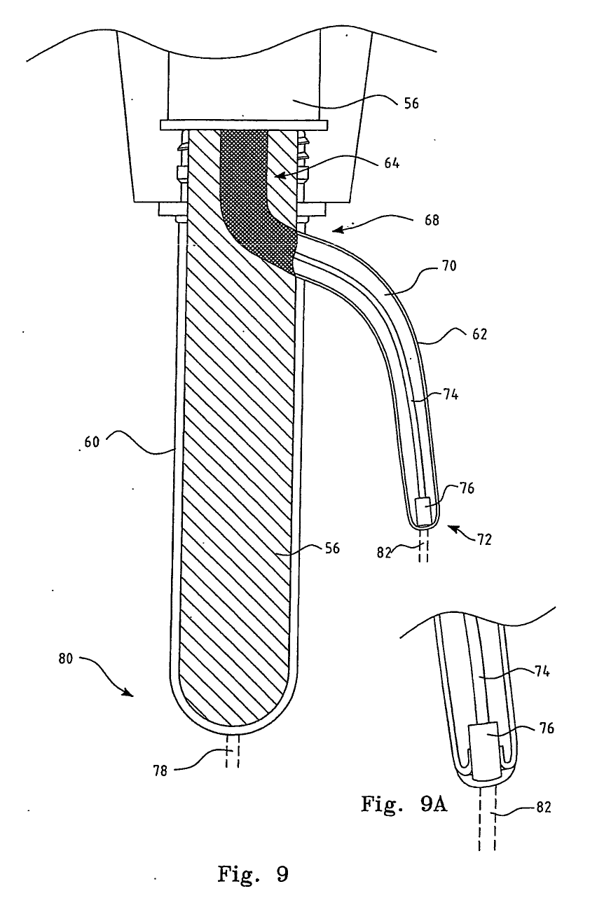

After closure of the die, but prior to the injection cycle of the preform, a flexible handle mandrel 70 is inserted into the main mandrel 56 through passage 64 and enters the handle portion of the preform cavity 62. The handle mandrel 70 is an inflatable airtight tube closed at its outer end 72 and formed of relatively stiff but flexible heat resistant material. As may be seen in the part sectioned view of the mandrel in FIG. 9, an internal cable 74 runs the length of the flexible tube 70, from the control module 66 (FIG. 7) to the closed outer end 72. The cable 74 is flexible but sufficiently stiff to aid in the insertion of the handle mandrel into the handle cavity.

The handle mandrel may be partially inflated prior to insertion into the main mandrel and thence into the handle part of the preform cavity to give additional rigidity for the tube to negotiate the bends of the passage . . . and the handle cavity.

The tube is so formed, that when fully inflated, the part located in the handle cavity of the die conforms to the shape and dimensions of the cavity, that is, it completely fills the cavity as may be seen in FIG. 9.

The closed outer end 72 of the handle mandrel tube 70 is provided with a projecting solid tip 76 as may be seen in the enlargement of FIG. 9A, having a generally cylindrical body and a diameter equal to the desired hollow centre of the handle. The cable 74 is connected to the inner end of the tip 74.

Before the injection cycle commences, the tube of the handle mandrel is inflated thus completely filling the handle portion of the preform cavity.

For a conventional symmetrical preform, there is a single injection point, or gate 78, at the tip 80 of the preform cavity 60. For the production of the present preferred embodiment of the preform however, a second injection gate 82 is provided at the end 72 of the handle portion of the cavity. Injection of PET through each gate is controlled during the mould cycle.

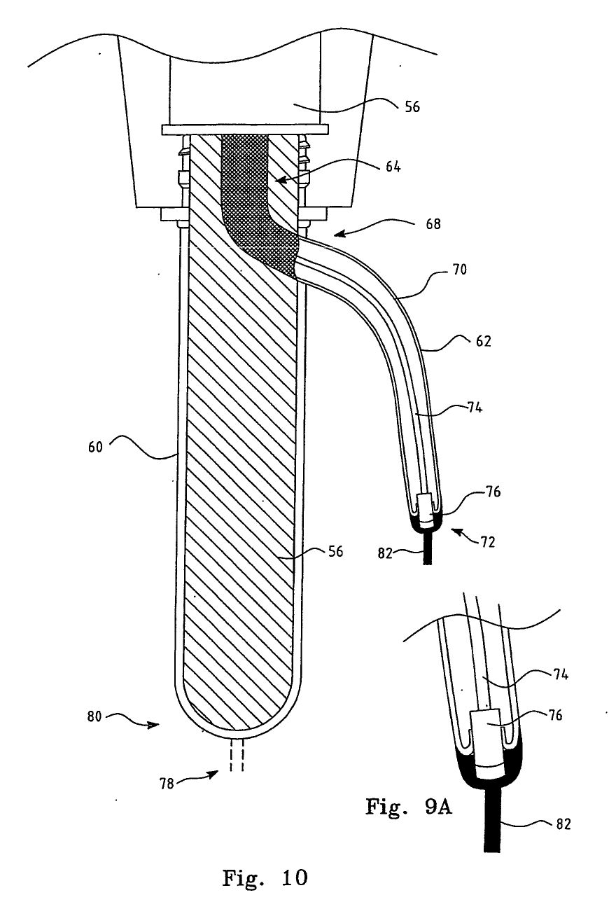

The control module 66 (FIG. 7) is provided with control means (not shown) for retracting the cable 74 connected to the tip 76 of the handle mandrel tube. The control module is further equipped to gradually retract the tube 70 from the handle portion of the cavity. With reference to FIG. 10, as PET enters through the handle tip gate 82, the cable 74 is tensioned by the control module to draw the tip 76 away from the end 72 of the handle cavity 62. The end of the tube now assumes the partially internally collapsed form shown in FIG. 10 maintaining the tip 76 central to the handle cavity and allowing the PET to flow around the tip.

The cavity is heated but the tip is not, so that PET continues to flow along the handle cavity walls but “goes off” adjacent the tip, thus securing the hollow passage 83 being formed by the withdrawing tip 76.

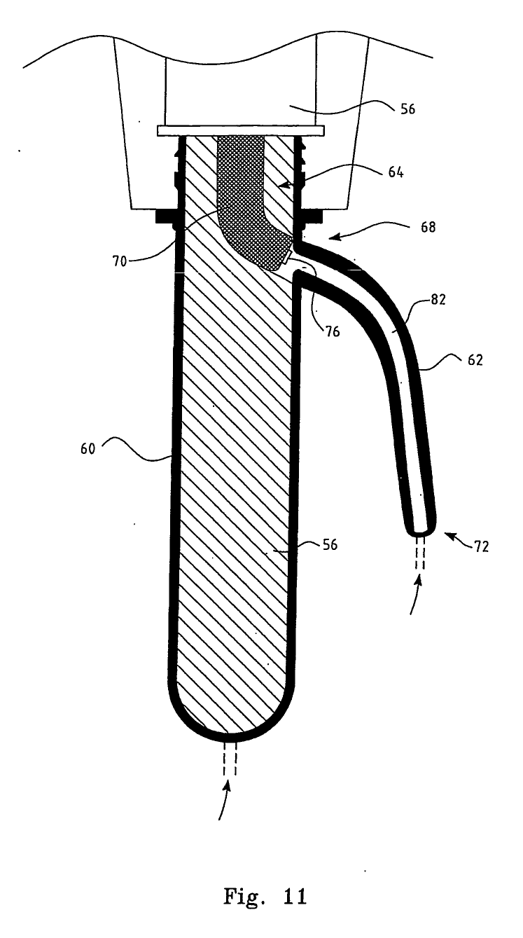

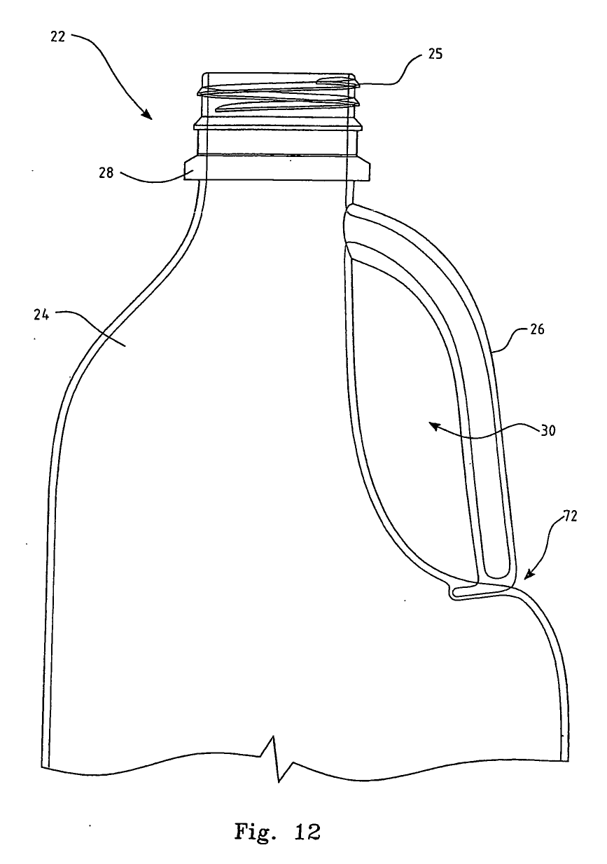

This process continues, with the tip continuing to form the hollow passage centrally within the handle until the injected PET has completely formed the handle portion of the preform. Meanwhile PET injected through the main preform gate has reached the junction of the handle and the main body of the preform. As the tip reaches the gap between the main mandrel and the entry to the handle it is paused briefly, allowing PET forming the walls of the main preform to envelop the tip, securing the opening between the interior of the main part of the preform and the connected handle. The tip and tube may then be fully withdrawn, or at least withdrawn into the main mandrel, and PET injection continues to fill the rest of the neck section of the preform as shown in FIG. 11.

The end of the handle may take a number of forms depending on the desired disposition of the handle in the final form of the blown container. The handle may be “free”, that is with a gap between the end of the handle and the body of the container as shown in FIG. 3 or the handle may be “captured” at its end by the blow moulding process so that the tip at the end is to some extent enveloped by the body of the container when blown to its final shape as shown in strictly integral at the lower end 72, nevertheless becomes attached to and derives support from the body 24 of the container.

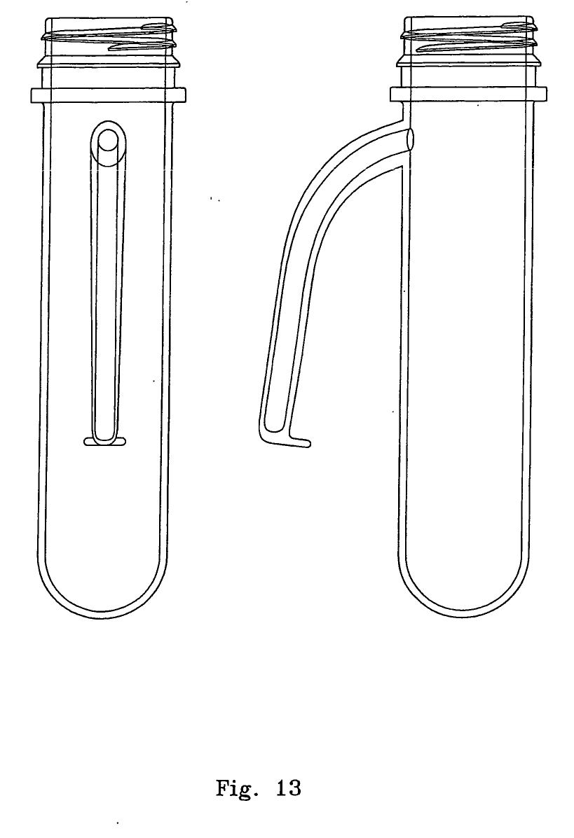

To make such attachment secure, the end of the handle as formed in the preform, may be provided with a shaped portion adapted to increase the purchase of the end of the handle when partly enveloped by the material of the container body, such as shown in FIG. 13. Such an end portion is adapted to engage mechanically with a blown portion of the container, the wall portion of which comes to envelop the end portion of the handle. Alternatively, or in addition, a chemical agent may be used as an adhesive to form a bond between the tip of the handle and the blown body of the container.

Stretch-Blow Moulding of Container with First Embodiment Preform

Regardless of whether the system employed is a single-stage or two-stage, the various sections of the preform must be temperature conditioned prior to insertion into the blow moulding die.

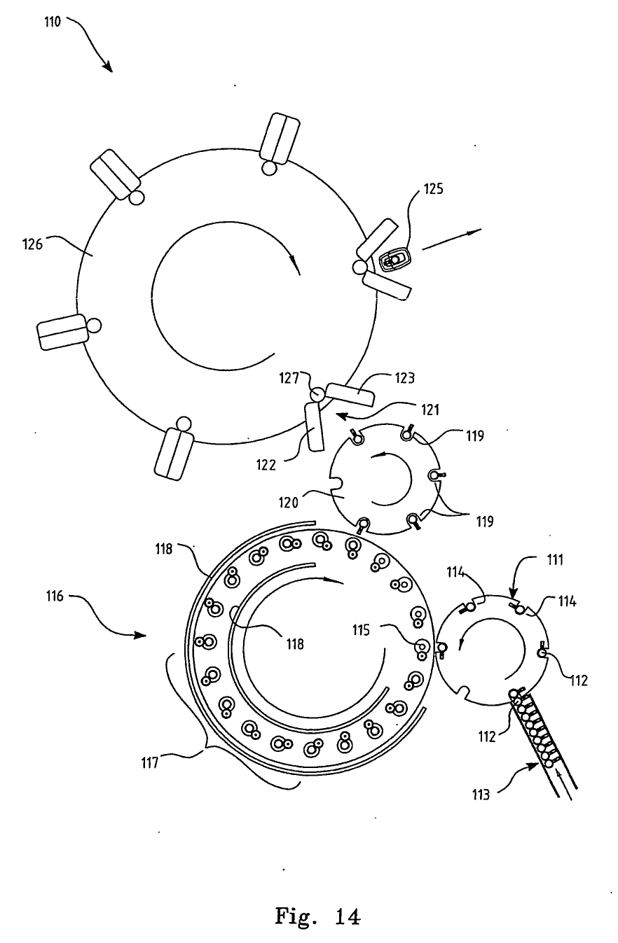

FIG. 14 illustrates a modified two stage stretch blow mould machine 110 for a two-stage process adapted to stretch blow mould preforms of any of the preferred embodiments according to the invention.

The machine 110 comprises a first carousel 111 adapted to receive integral hollow handle preforms 112 from inclined chute 113 into apertures 114 spaced around the periphery thereof.

As first carousel 111 rotates it moves, via apertures 114 the preforms 112 from the chute 113 to a second carousel loading position where the preform 112 is inverted and transferred to a spindle 115 mounted near the periphery of second carousel 116.

A sector of approximately 270° of second carousel 116 is arranged as a preheating sector 117 where the preforms 112 are progressively heated by a heating banks mounted in opposed relationship to the path of travel of the preforms.

The suitably preheated preforms 112 are loaded consecutively into apertures 119 of a third carousel 120 which acts as a transfer mechanism to suitably orient the preforms 112 about their longitudinal axis with regard to the handle location and present them to a mould cavity 121 comprising first half mould 122 and second half mould 123.

Mould cavities 121 are mounted on the periphery of a fourth carousel 126. During their travel through approximately a 270° sector the half moulds 122, 123 rotate to a closed position about their hinge axis 127 and, whilst closed, the preform 112 enclosed therein is blown and biaxially stretched as described above to produce an integral handle, blown container 125. Containers 125 are ejected as illustrated when the half moulds open preparatory to receiving a fresh, preheated preform 112.

Typically, as the preform passes through the heating sector in an inverted position with the axis of the preform vertical, it is rotated so that each section of the preform is heated evenly. The non-expandable portion of the preform including the neck and locating ring are substantially shielded from the pre-heat (or reheat in a single stage machine) process by appropriate guarding.

The asymmetry of a preform having a projecting handle portion requires that special care be taken to ensure that the handle portion which will pass closer to the heat source during rotation, is not overheated. This may be done by providing a partially shielding shroud for example, designed to allow sufficient heat to reach the section of the main body of the preform positioned opposite the inside of the handle, while protecting the handle from excessive heat.

### Second Preferred Preform Embodiment

### Integral Handle, Two Points of Connection

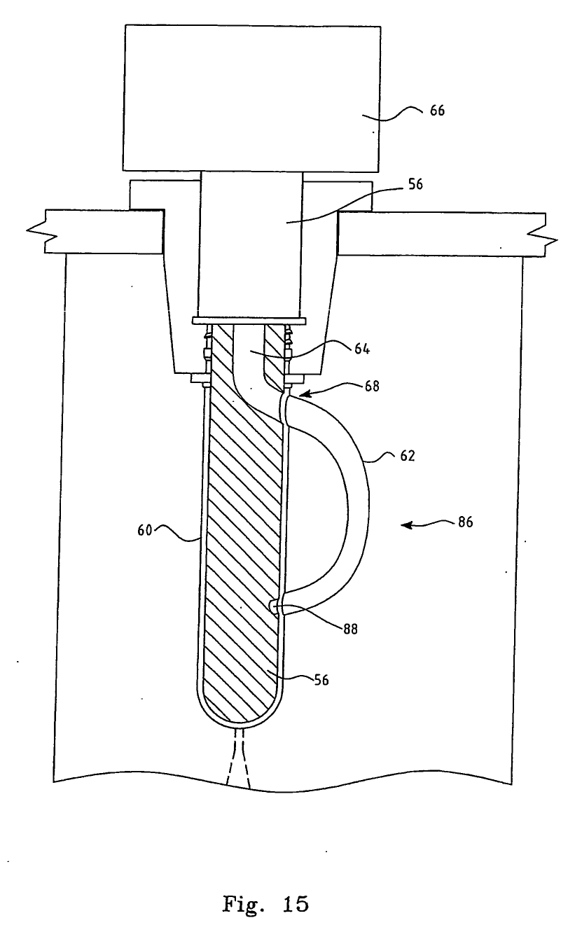

In a second preferred embodiment of the invention, the handle of the preform is connected to the main body of the preform at a first upper connection point, that is, towards the neck region, and at a second connection point as seen in FIG. 15 so as to form a loop 86. The process for producing this second embodiment is similar of the preform is formed by use of a flexible inflatable tube with a passage forming tip.

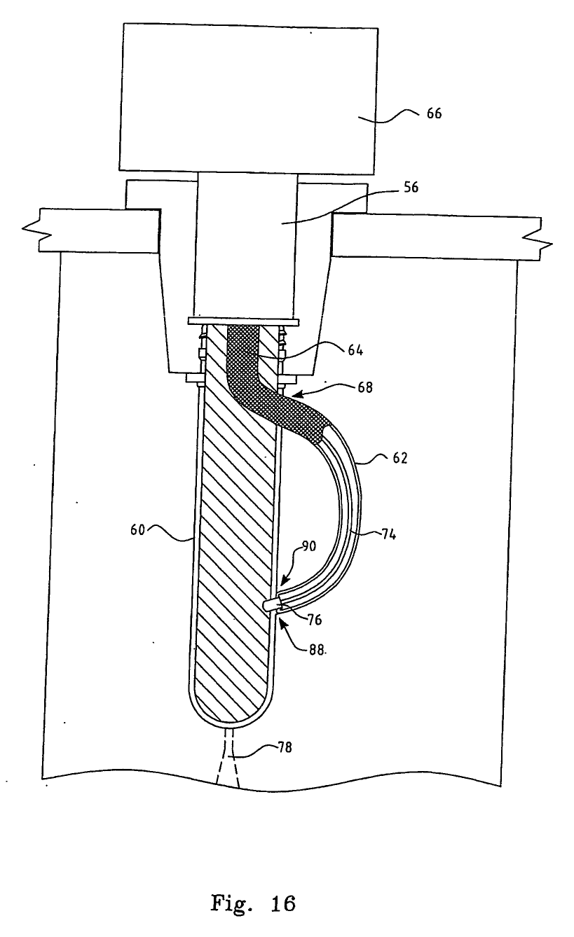

However, in this embodiment the main mandrel 56 is provided with a pocket 88 opposite the second connection point (that is, the point of connection furthest away from the neck of the container). As shown in FIG. 16, the pocket 88 is adapted to accept the solid tip 76 of the flexible handle mandrel 70 when this is fed through the handle cavity 62.

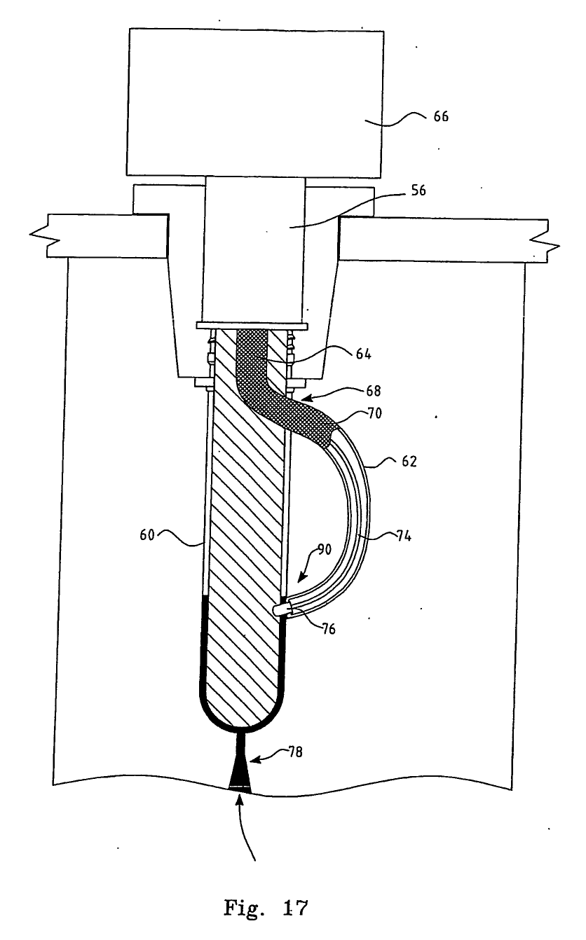

Following the insertion of the flexible handle mandrel into the handle cavity and the nesting of the tip in the pocket, injection of the PET commences. The injection sequence first ensures that PET enters through the main injection gate 78 and completes the formation of the main body of the preform past the second handle connection point 90 as may be seen in FIG. 17, thus allowing the tip 76 to secure the opening between the main part of the preform and the handle. The tube 70 and tip 76 may now be gradually withdrawn as previously described to form the hollow handle. Withdrawal of the tip 76 is paused briefly when at the position of the first connection point 68 to allow PET to flow around the tip to secure the opening between the main part of the preform and the handle at the first connection point.

Stretch-Blow Moulding of Container with Second Embodiment Preform

The process of blow moulding of the preform is largely as described above for the first embodiment. However the two connection points of the present embodiment, require provision for the stretching of the main body of the preform between the two connection points of the hollow handle.

This is so because the process of blow moulding a container from a preform considerably shorter than the depth of the container requires that the preform be stretched longitudinally prior to the injection of compressed air, as alluded to above.

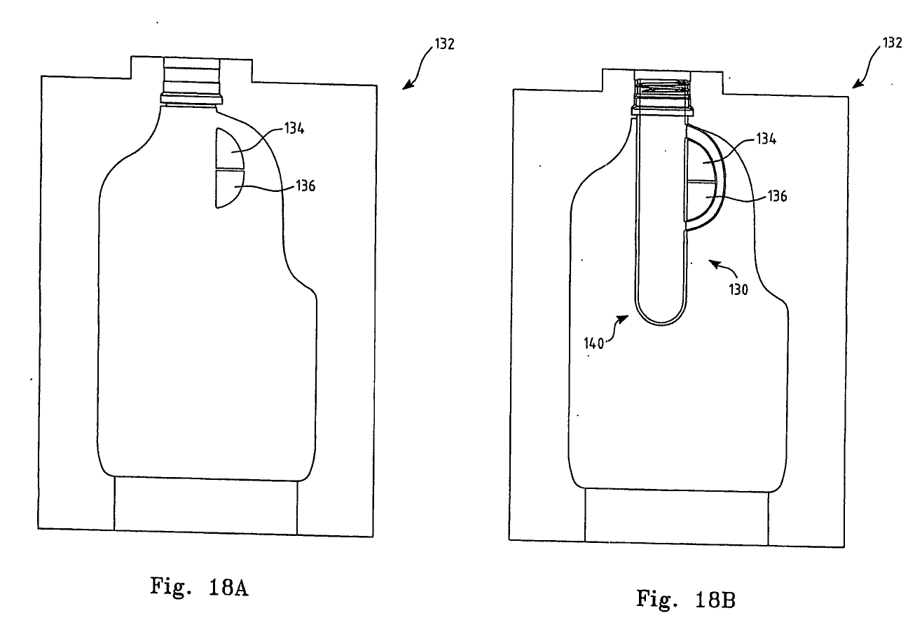

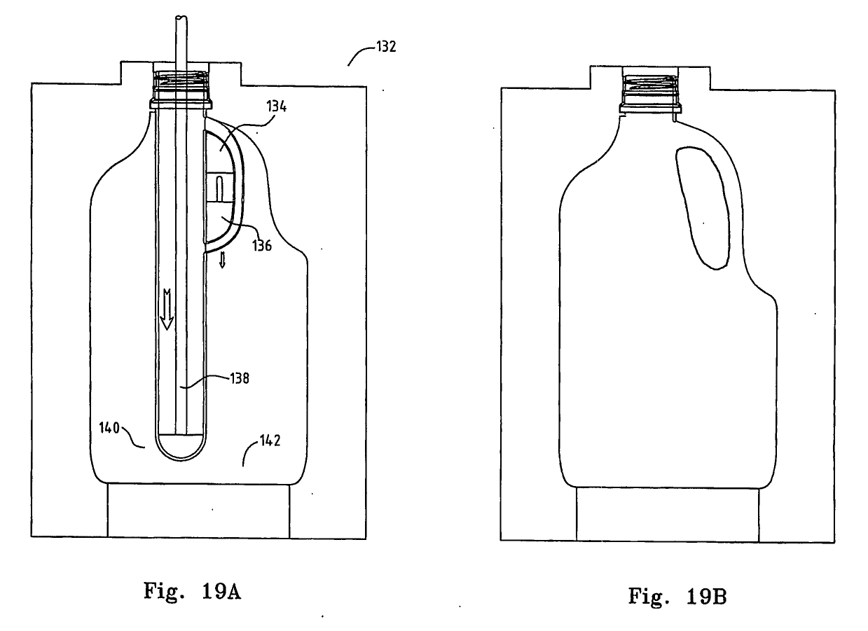

As can be seen from FIGS. 18A to 19B the preform 130 after it initially enters the blow moulding die 132 in FIG. 18B is mechanically stretched by an inserted stretching rod 138 to bring the tip 140 of the preform 130 to near the base 142 of the cavity. This stretching must be simultaneously accompanied by a proportional stretching of the main portion of the preform between the two connection points, and indeed of the handle portion itself.

This is effected by the provision of sections 134 and 136 in the die defining the space between the handle and the main body of the preform. The second of these sections 136 is linked mechanically to the stretching device to slide the section towards the bottom of the cavity at a rate and for a distance proportional to that of the stretching device of the main portion of the preform. Thus the portion of the preform wall of the main body of the preform between the handle connection points is stretched to conform to stretching of the remaining circumference portion of the wall at that section of the preform. Once the stretching is complete, air is injected and the biaxial stretch blow moulding of the container is completed.

1. A preform for a container comprised of orientable plastics material and arranged so that the resultant blown container will include a hollow handle; said preform comprising a moulded structure having a neck portion and an expandable portion below the neck, a hollow handle portion of orientable plastics material integrally connected at least at a first end to said preform which when the container is formed constitutes said handle, and wherein interior surfaces of said hollow handle portion form a continuum with interior surfaces of said expandable portion.

2. A method of moulding a preform comprising a neck portion, a substantially cylindrical expandable body portion and a hollow handle portion integrally connected at least at one point to said expandable body portion; said method comprising the steps of:
(a) preparing an injection moulding die in which the exterior form of said body portion and said handle portion of said preform are defined by a cavity formed by cooperating halves of said injection die,
(b) preparing a main body forming mandrel for insertion into said cavity said mandrel provided at an outer end with a control module,
(c) providing a passage extending from said control module substantially centrally through said mandrel; said passage curving to emerge at a side of said mandrel opposite said at least one point,
(d) providing a flexible handle mandrel controlled by said control module; said mandrel adapted for insertion through said passage and into said handle portion of said cavity.

3. The method of claim 2 wherein said flexible mandrel is an inflatable flexible tube of heat resistant material.

4. The method of claim 2, wherein said tube is sealed at an outer end.

5. The method of claim 4, wherein said outer end is provided with a solid tip projecting through said outer end.

6. The method of claim 5, wherein said tip is of substantially cylindrical form, said tip oriented with its axis substantially aligned with the axis of said tube.

7. The method of claim 5, wherein the diameter of said tip defines the diameter of the interior of the hollow handle when formed.

8. The method of claim 3, wherein a cable extends through said tube from said control module to said tip.

9. The method of claim 3, wherein said control module is adapted to extend and retract said tube.

10. The method of claim 3, wherein said control module is adapted to inflate and deflate said tube.

11. The method of claim 5, wherein said method for moulding a preform with a hollow handle attached at one point to said body comprises the further steps of:
(a) providing a first injection gate at an outer end of said handle portion of said cavity,
(b) inflating said tube so as to completely fill said handle portion of said cavity,
(c) injecting a flowable plastic material through said gate so as to envelop said tip,
(d) arranging said control module to partially deflate said tube,
(e) arranging said control module to gradually withdraw said tube from said handle portion of said cavity at a rate commensurate with the injection rate of said flowable material,
(f) injecting said flowable material through a second injection gate at an outer end of said body portion of said cavity,
(g) continuing injection of flowable material through both gates until said tip bridges a gap between said handle portion and said main body forming mandrel,
(h) withdrawing said tube and said tip into said main body forming mandrel,
(i) continuing injection of flowable material to completely fill said cavity.

12. The method of claim 5, wherein said method for moulding a preform with a hollow handle connected at two points to said body; said handle extending form a first connection point to a second connection point, said method comprises the further steps of:
(a) providing a pocket for nesting said tip in said main body mandrel opposite said second connection point,
(b) inserting said tube through said handle portion of said cavity to nest said tube in said pocket,
(c) inflating said tube,
(d) injecting flowable material through an injection gate at an outer end of said main body portion of said cavity,
(e) continuing said injection of flowable material until said material envelops said tip,
(f) gradually withdrawing said tube commensurate with a rate of injection of said flowable material so as to maintain said tip enveloped by said material,
(g) pausing withdrawal of said tube when said tip bridges a gap between said-handle portion and said main body forming mandrel at said first connection point,
(h) withdrawing said tube and said tip into said main body forming mandrel,
(i) continuing injection of flowable material to completely fill said cavity.

13. A method of forming a container of plastic material having an integral hollow handle; said method comprising:
(a) forming a preform according to claim 2, having a neck portion and an expandable portion below the neck portion, said preform having a hollow handle portion integrally connected at least at a first end to said preform, and
(b) preheating said preform to condition said plastic material,
(c) performing a blow moulding operation on said preform to expand the expandable portion and said handle portion to form the body and handle of said container.

14. A container provided with a hollow handle, said handle integrally connected to at one point to said container, said container formed by stretch blow-moulding from a preform according to claim 2, wherein an outer end of said handle is separated by a gap from said container.

15. A container provided with a hollow handle, said handle integrally connected at least at one point to said container, said container formed by stretch blow-moulding from a preform according to claim 2, wherein an outer end of said handle is adapted for at least partial capture within a portion of a wall of said container when said container is stretch blow-moulded from said preform.

16. A container provided with a hollow handle, said handle integrally connected to said container at a first point and a second point so as to allow the insertion of the fingers of a hand of a user, said-container formed by stretch blow-moulding from a preform according to claim 12.
